(19) United States
(12) Patent Application Publication
(10) Pub. No.: US 2020/0081726 A1
(43) Pub. Date: Mar. 12, 2020

(54) HIERARCHICAL, SYSTEM-INDEPENDENT INTERFACE LAYOUT DEFINITIONS FOR NATIVE MOBILE APPLICATIONS

(71) Applicant: ServiceNow, Inc., Santa Clara, CA (US)

(72) Inventors: Oleg Yakov Sherman, Gedera (IL); Itay Braun, Tirat Carmel (IL); Boaz Zvi Hecht, Foster City, CA (US)

(21) Appl. No.: 16/128,370

(22) Filed: Sep. 11, 2018

(51) Int. Cl. G06F 9/451; G06F 3/0484

(52) U.S. Cl. CPC G06F 9/451; H04L 67/12; G06F 3/0484

(57) ABSTRACT

A wireless communication device may include a communication interface, a screen configured to display a graphical user interface (GUI) of a native application, a processor, and memory containing instructions of the native application that, when executed by the processor, cause the wireless communication device to perform operations including: generating a request that refers to data accessible by way of a server device; transmitting the request to the server device; receiving the data from the server device, wherein the data includes: (i) content for display by the native application, and (ii) a recursively-defined, cell-based arrangement of the content, with identifiers mapping units of the content to cells within the arrangement; generating a GUI that represents the content spatially organized according to the arrangement and the mapping; and displaying the GUI.

### BACKGROUND

Native mobile applications are programs specifically designed to execute on the operating system of a mobile device, such as a mobile phone, tablet, smartwatch, or any other type of wireless communication device. Such native applications may be pre-packaged with the device or downloaded to the device at a later time. These applications may allow access to data of a web site or server, and may present this data in a customized fashion on a graphical user interface (GUI). This, and the ability for native applications to request specific subsets of the data that are to be presented, results in these applications having numerous advantages over accessing the same data by way of a web browser.

Nonetheless, native applications (and web browser based access as well) suffer from the inherent problems of differing configurations, operating systems, and screen sizes, because content may be displayed inconsistently across different devices. Furthermore, users of these devices may be inclined to interact with them differently than they would with other devices. For example, a user interacting with a smartphone, smartwatch, tablet, and the like, is more inclined to view and interact with the device from multiple angles, often rotating the orientation of the device to suit the user's preference. All of these of these factors may lead to problematic results by not creating a consistent user experience with an application used across such differing wireless communication devices, because the application may render and scale differently across them. User experience may suffer due to these problems and result in inconsistent and potentially frustrating user experiences.

### SUMMARY

In order to provide a responsive and dynamic user interface that is largely device, platform, and orientation independent, a native application may request and receive information for display from a server device. This information may include the content for display (e.g., text and images), and an arrangement of the content (e.g., an ordering and/or screen locations of the text and images).

A native application may display the content such that it is arranged and scaled accordingly. Thus, the user may easily view and interact with the content (and/or its particular arrangement) in spite of the limited screen size of the wireless communication device, and regardless of the device displaying the content, the operating system and/or platform running on that device, or the orientation of that device from the user's perspective. One way the native application may do this is pursuant to a recursively-defined cell-based arrangement of the content (e.g., by implementing a hierarchical arrangement of cells and subcells within those cells to display content in a consistent manner across numerous devices). In this way, the native application may cause the wireless communication device to display the content pursuant to an arrangement, then continue to update the displayed content pursuant to a particular procedure, subroutine, or function that recurses one or more times until a specified condition is met.

Accordingly, a first example embodiment may involve a wireless communication device comprising: a communication interface, a screen configured to display GUIs of a native application, a processor, and memory containing instructions of the native application that, when executed by the processor, cause the wireless communication device to perform operations. The operations may include generating a request that refers to data accessible by way of a server device. The operations may further include transmitting, by way of the communication interface, the request to the server device. The operations may further include receiving, by way of the communication interface, the data from the server device, where the data includes: (i) content for display by the native application, and (ii) a recursively-defined, cell-based arrangement of the content, with identifiers mapping units of the content to cells within the arrangement. The operations may further include generating of a GUI that represents the content spatially organized according to the arrangement and the mapping. The operations may further include displaying, on the screen, the GUI.

A second example embodiment may include generating, by a native application executing on a wireless communication device, a request that refers to data accessible by way of a server device. The second example embodiment may further include transmitting, by way of a communication interface, the request to the server device. The second example embodiment may further include receiving, by way of the communication interface, the data from the server device, wherein the data includes: (i) content for display by the native application, and (ii) a recursively-defined, cell-based arrangement of the content, with identifiers mapping units of the content to cells within the arrangement. The second example embodiment may further include generating of a GUI that represents the content spatially organized according to the arrangement and the mapping. The second example embodiment may further include displaying, on a screen of a wireless communication device, the GUI.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A is a message flow diagram, in accordance with example embodiments.

FIG. 6B is a message flow diagram, in accordance with example embodiments.

FIG. 7A is part of an example JavaScript Object Notation (JSON) file defining a GUI, in accordance with example embodiments.

FIG. 7B is part of an example tree-based hierarchy for defining elements in a GUI, in accordance with example embodiments.

FIG. 7C depicts a GUI, in accordance with example embodiments.

FIG. 7D is part of an example class hierarchy for defining elements in a GUI, in accordance with example embodiments.

FIG. 8A depicts a GUI, in accordance with example embodiments.

FIG. 8B depicts a GUI, in accordance with example embodiments.

FIG. 8C depicts a GUI, in accordance with example embodiments.

FIG. 8D depicts GUI, in accordance with example embodiments.

FIG. 8E depicts a GUI, in accordance with example embodiments.

FIG. 8F depicts a GUI, in accordance with example embodiments.

FIG. 8G depicts a GUI, in accordance with example embodiments.

FIG. 8H depicts a GUI, in accordance with example embodiments.

FIG. 8I depicts a GUI, in accordance with example embodiments.

FIG. 8J depicts a GUI, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for GUI development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data is stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. Example Computing Devices and Cloud-Based Computing Environments

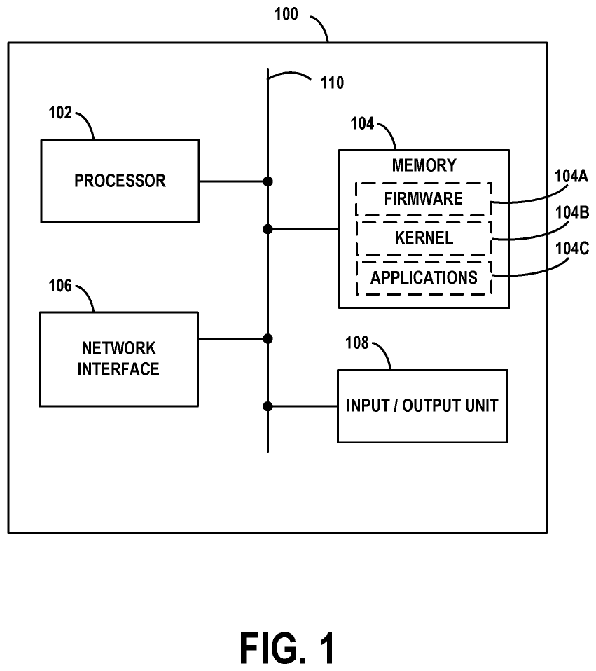

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more instances of computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

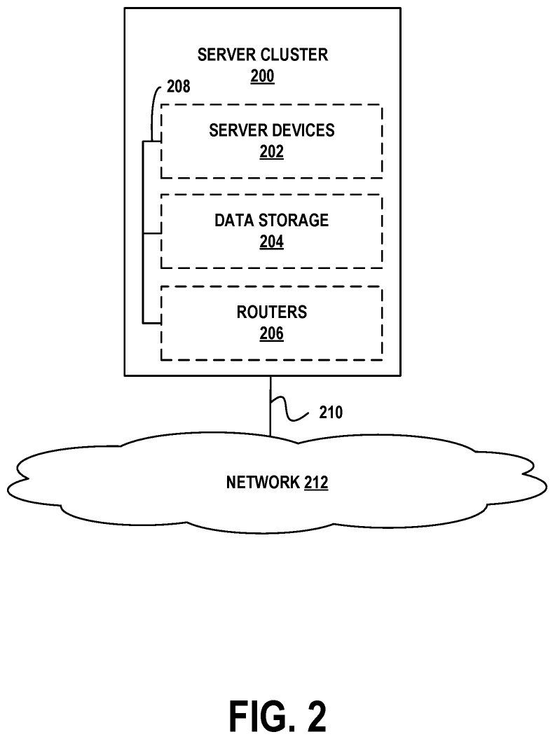

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. Example Remote Network Management Architecture

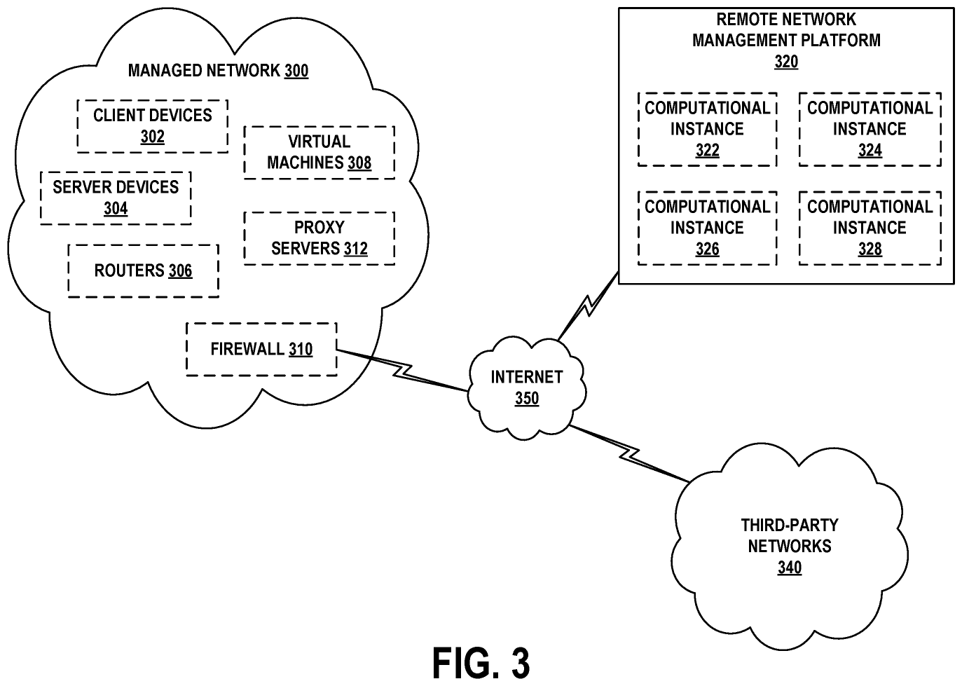

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation.

The multi-instance architecture of remote network management platform 320 is in contrast to conventional multi-tenant architectures, over which multi-instance architectures have several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

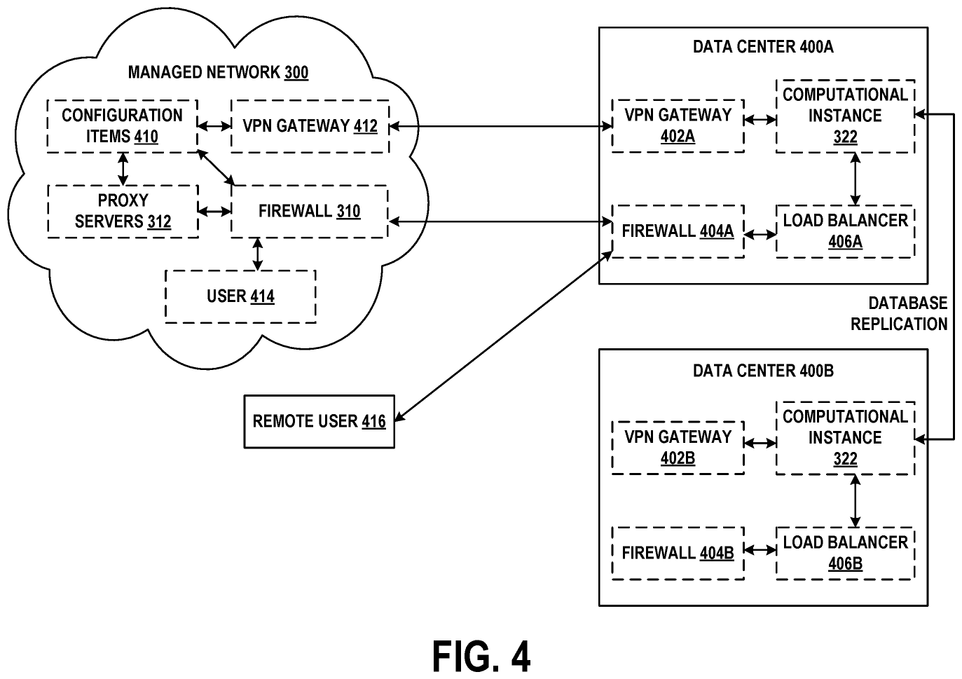

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0—10.255.255.255 or 192.168.0.0—192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

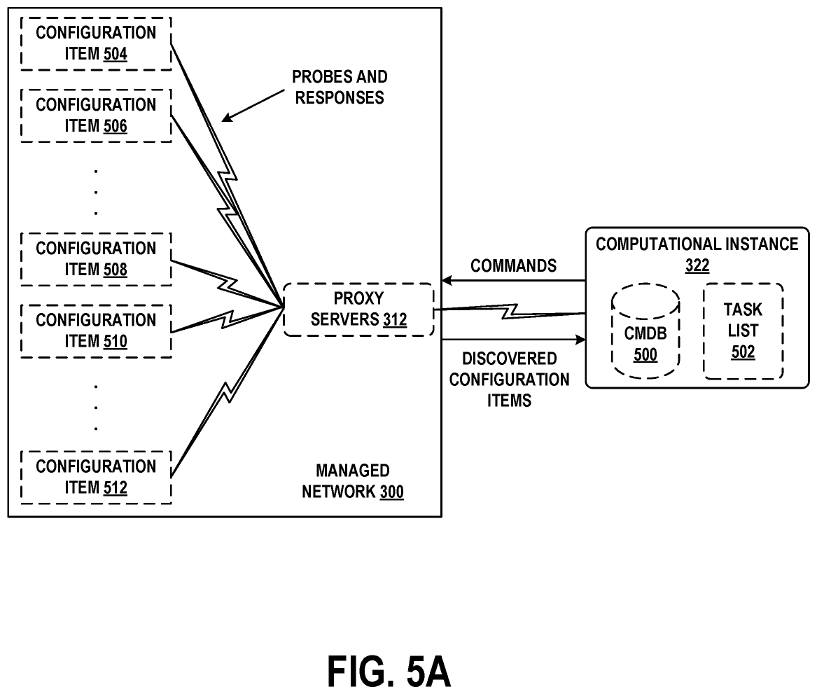

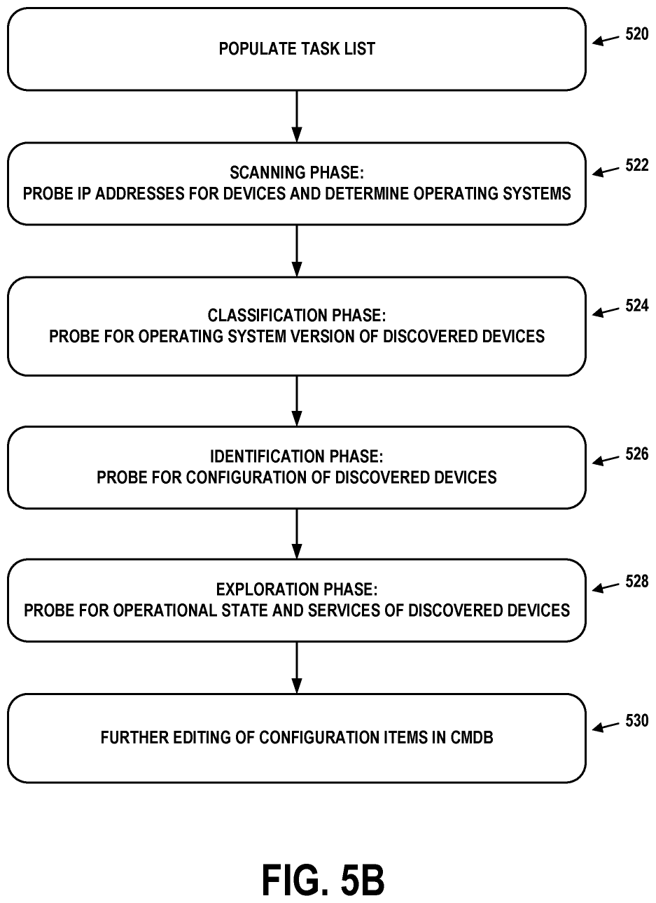

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. Example Dynamic View Mode

For purposes of the embodiments discussed herein, a “wireless communication device” may be any type of computing device that accesses a network by way of a wireless interface. Nonetheless, other types of devices may use and benefit from these embodiments.

The use of wireless communication devices, such as smartphones, smartwatches, tablets, and so on has become ubiquitous. As such, users of a remote network management platform may expect to be able to obtain access thereto from such wireless communication devices around the clock and from a variety of physical locations. However, at least three issues exist.

First, the relatively small screen size of a wireless communication device limits the amount of information that can be displayed at any one point in time on the device. For instance, a typical smartphone may have a diagonal screen size of 6 inches, whereas a desktop computer may be attached to a monitor with a 30 inch (or more) diagonal screen size. Thus, the amount and type of data displayed at any one point in time may be severely limited on wireless communication devices as opposed to desktop (or even laptop) computers. Notably, web pages provided by the remote network management platform may display appropriately on a large screen, but might be shrunk to a nearly unreadable size on the screen of a wireless communication device.

Second, there are countless configurations and screen sizes for wireless communication devices, and an application may render and scale differently across different devices. These differences can be between different wireless communication devices from the same manufacturer (e.g., a tablet versus a smartphone) or comparable wireless devices from different manufacturers (e.g., two similarly sized smartphones with different button placements). This result is often problematic because it can lead to inconsistent user experiences with an application used across such wireless communication devices. This problem is increased by the fact that many of these wireless communication devices also use different versions of a particular operating system or platform, or different operating systems or platforms, altogether. Users of these applications who experience these problems between different wireless communication devices may be left with inconsistent (potentially frustrating) impressions.

Third, users often interact with certain kinds of wireless communication devices differently than they would with other devices. For example, a user interacting with a smartphone, smartwatch, tablet, and the like, is more inclined to view and interact with the device from multiple angles, often rotating the orientation of the device to suit the user's preference, than with other, more stationary devices (e.g., a television, desktop computer, etc.). However, even when rotating the device, the user may expect to see a seamless continuity of content, and the arrangement of that content, regardless of the orientation of the device. As discussed above, this expectation may be problematic because it can lead to inconsistent user experiences with an application used across such wireless communication devices because the application might not only render and scale differently across different devices, but also across different orientations of the same device (e.g., in a portrait versus landscape orientation modes). Without this continuity of experience while rotating the device, the user may become frustrated and underutilize the device (e.g., only view content in a portrait mode, even if it is better suited for horizontal viewing), or may stop viewing content on the device altogether.

The embodiments herein help to address these user interfaces problems by providing a native application executing on a wireless communication device. The native application is compiled or interpreted directly by the device by way of its operating system and/or supporting libraries. Unlike a generic web browser or applications that download for execution in a web browser, the native application is designed specifically for communicating with a computational instance of a remote network management platform.

By way of this communication, a server device (e.g., of a computational instance) may provide content for display pursuant to a particular arrangement on the wireless communication device based on instructions that are largely device, platform, and orientation independent. These instructions may arrange and scale the content on the wireless communication device accordingly (e.g., via a set of instructions detailing a recursively-defined, cell-based arrangement of content, regardless of the device). Thus, content and/or its arrangement can be designed to be easily readable even with the limited screen size of the wireless communication device, no matter what device the content is displayed on, the operating system and/or platform running on that device, or the orientation of that device from the user's perspective.

Furthermore, the native application may be able to determine when the content on the wireless communication device is modified and responsively take further action. For instance, the native application may detect when a user has modified the content on the wireless communication device via a displayed GUI. In some cases, the wireless communication device may determine that it should request further content and instructions for arranging that content in accordance with layout instructions using the native application (e.g., in one or more previously defined cells, rows, etc.).

Along with the content and/or arrangement provided to the wireless communication device, the native application may update its GUI to reflect changes (e.g., due to navigation to changing values of displayed data) made by a user based on a number of factors. For example, when a user rotates the device (e.g., from portrait to landscape) the native application may respond by maintaining the attributes and proportions of the previously displayed screen, just in a different orientation. Alternatively, the native application may automatically scale the previously-displayed content in a more appropriate or appeasing view based on the rotated orientation (e.g., automatically scale the content that was displayed in portrait view to fit and fill a landscape view). In this way, when the native application determines that the wireless communication device has changed physical orientation between landscape and portrait orientation modes, it can generate an updated GUI that represents the content spatially organized according to a particular arrangement. Further, because the screen of the wireless communication device may have different relative dimensions in the landscape and portrait orientation modes, the updated GUI may also contain less or more of the content than the GUI prior to updating.

Additionally, the native application may request, from one or more server devices, further content and arrangement for displaying that updated content based on a set of previously-used and/or previously-defined interactions with the server devices. For example, based on previously displaying content in accordance with an arrangement (e.g., a recursively-defined, cell-based arrangement of content), the native application may generate a request for additional content that the wireless communication device does not have stored locally (e.g., images, text, or both), receive the updated content, and display that content based on instructions that display the updated content similarly to the previous instructions. The result can be a dramatically improved user experience that allows for seamless, adaptive scaling across multiple devices, platforms, and device orientations, all without crowding the local memory and storage of the wireless communication device.

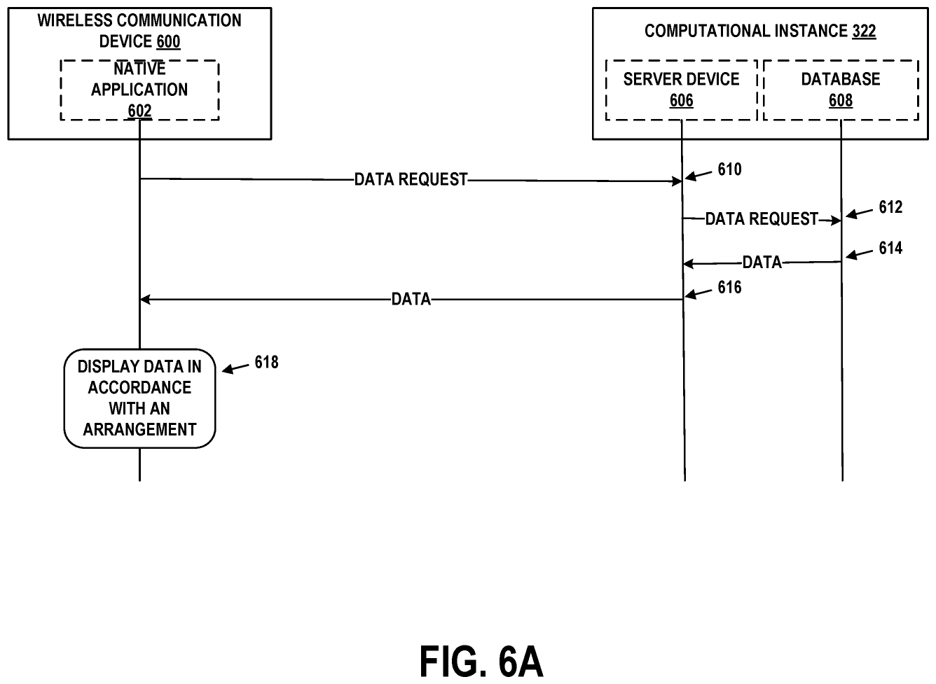

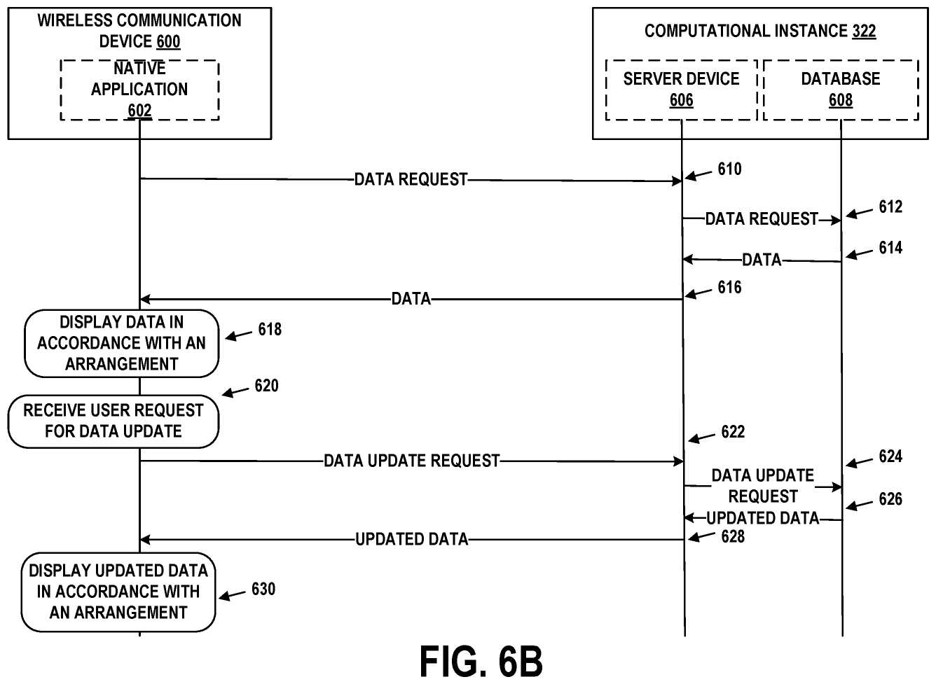

For sake of comparison, FIG. 6A depicts a transaction between the native application and a server device when the wireless communication device is executing the native application and displaying content pursuant to a particular arrangement, and then FIG. 6B depicts a similar transaction but including updating that content in light of a user's interaction with and modification of the displayed content.

In FIG. 6A, wireless communication device 600 may include a processor, memory, one or more communication interfaces, a screen capable of displaying a GUI (e.g., a touchscreen), and so on. Wireless communication device 600 may also contain, among other software modules, native application 602.

Wireless communication device 600 may be configured to communicate with server device 606, which is part of computational instance 322, for example. Server device 606 may, in turn, access database 608 to obtain information to transmit to wireless communication device 600, as well as to store information received from wireless communication device 600.

At step 610, native application 602 may transmit a data request to server device 606. The data request may be for data to display on a GUI of native application 602, and may be transmitted in response to user activity and/or based on other criteria.

At steps 612 and 614, server device 606 may request and receive the requested data from database 608. In some embodiments, server device 606 may omit these steps if it contains a copy of the requested data.

At step 616, server device 606 may transmit the requested data to native application 602. This data may include content for display on the GUI as well as define a particular arrangement of this content, and instructions for displaying the content pursuant to the particular, defined arrangement (e.g., a recursively-defined, cell-based arrangement of content).

At step 618, in response to receiving the data, native application 602 may display the content on the GUI in accordance with the arrangement. As an example, the native application 602 may display the content as a vertical or horizontal list of elements providing parameters and associated values, all mapped pursuant to a recursively-defined, cell-based arrangement of content.

FIG. 6B depicts a transaction similar to that of FIG. 6, but also shows updating that content in light of a user's interaction with and modification of the content. At step 610, native application 602 may similarly transmit a data request to server device 606. At steps 612 and 614, server device 606 may request and receive the requested data from database 608. At step 616, server device 606 may transmit the requested data to native application 602, and the requested data may include content for display on the GUI as well as a particular, defined arrangement of this content (e.g., a recursively-defined, cell-based arrangement of content).

At step 618, in response to receiving the data, native application 602 may similarly display the content on the GUI in accordance with the arrangement. For example, the content may be displayed as a vertical list of rows providing parameters, and associated values, all mapped pursuant to a recursively-defined, cell-based arrangement of content (e.g., utilizing the one or more identifiers within one or more of the recursively-defined cells).

At step 620 (which may take place before, after, or in response to reception of the data of step 618), at some point after the content is displayed, native application 602 may receive a user request to update the data. For instance, the user may change the value of one of the displayed content parameters (e.g., selecting a menu or a particular value to edit).

Thus, at step 622, native application 602 may transmit, to server device 606, a data update request with the parameter as changed. At steps 624 and 626, server device 606 may transmit the updated data to database 608 and receive an acknowledgement that the data has been updated or a copy of the updated data.

At step 628, server device 606 may transmit, to native application 602, a copy of the updated data. This copy may also include any updates made to the overall content and layout of the GUI due to the change in content. For example, if the data as updated takes up more vertical space to display in the GUI, the updated GUI may omit other information that was previously displayed in order to fit the parameter. In another example, the updates might not change anything about the overall layout of the GUI, but may just replace the content that is displayed therein (e.g. text, images, both). Thus, if content is displayed pursuant to a certain set of layout parameters (e.g., a vertical list of rows incorporating a recursively-defined, cell-based arrangement of content), as the content is updated, the server device may not have to send updated layout parameters. Instead, the server device may just send content updates containing data that goes in those defined layout parameters. Additionally, at step 630, native application 602 may refresh its GUI to reflect any such updates.

Furthermore, in this fashion, database 608 is updated based on the most recent input from the user of wireless communication device 600. In this way, the data displayed on the GUI of native application 602 and stored in database 608 may be synchronized and updated instead of requiring duplicative processing and storage.

### VI. Example GUIs

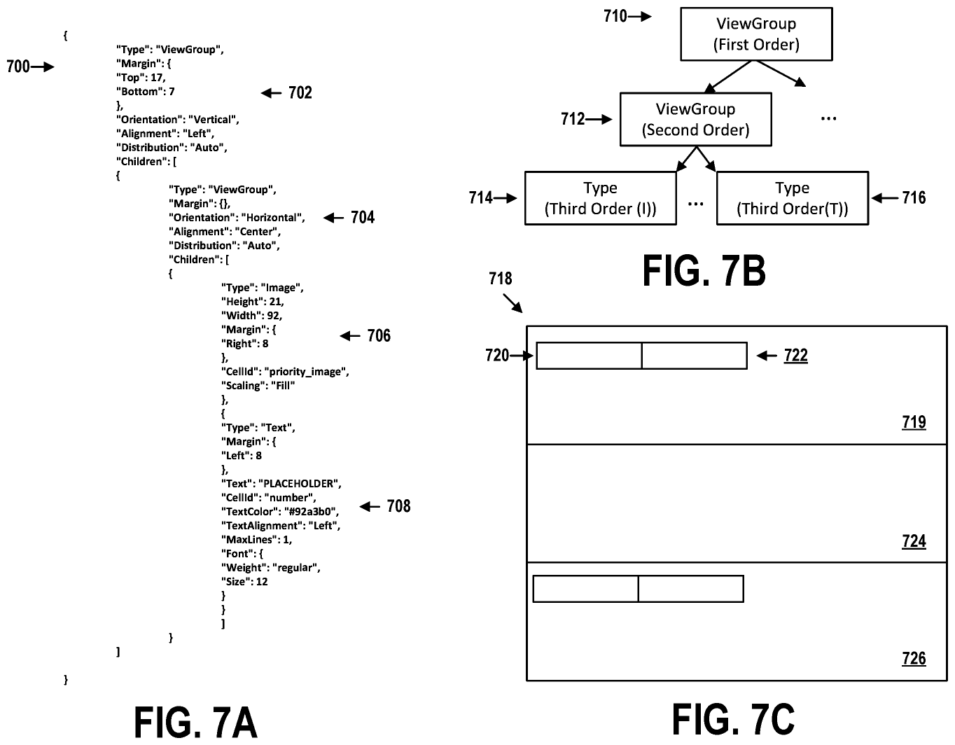

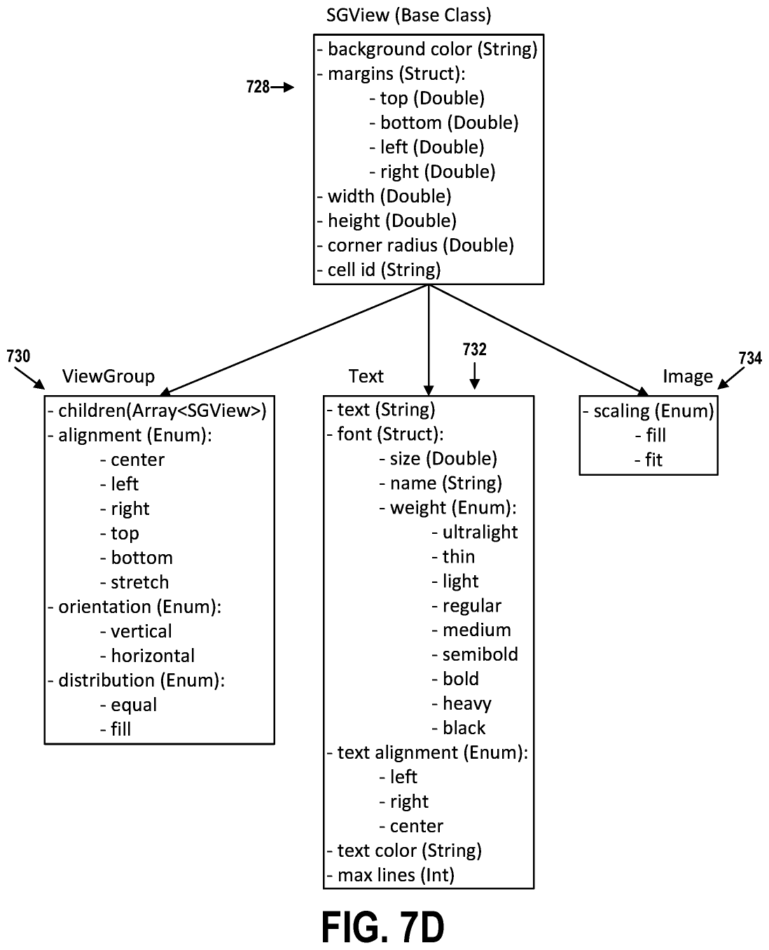

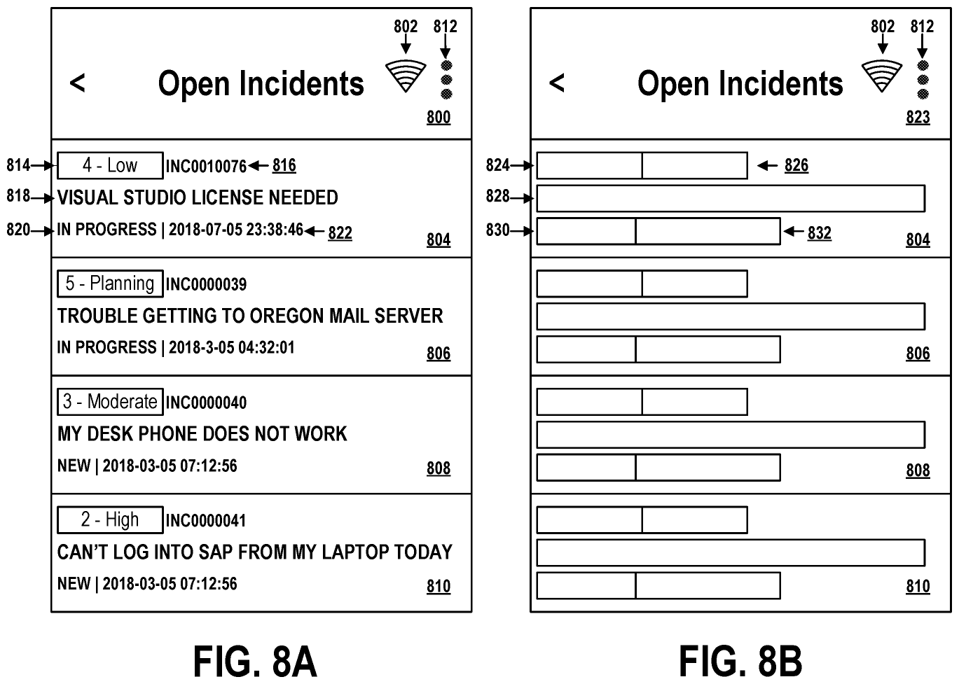

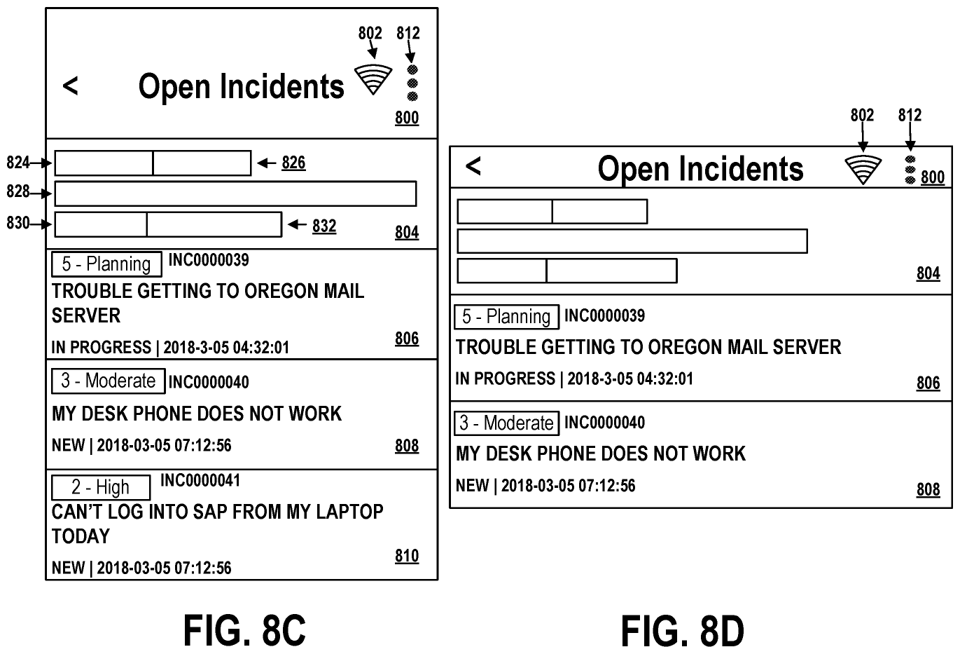

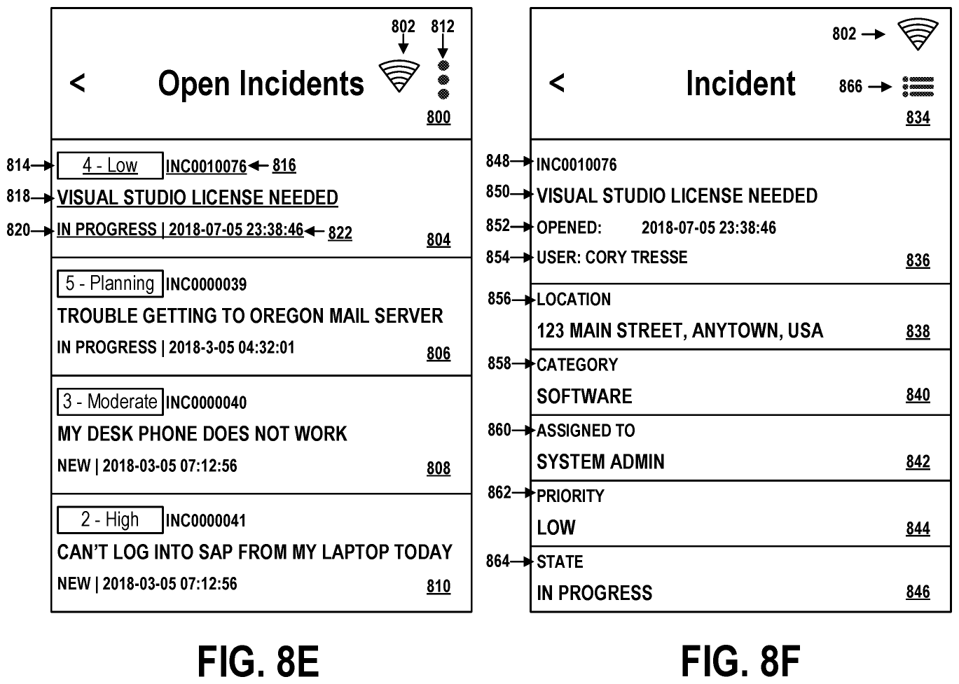

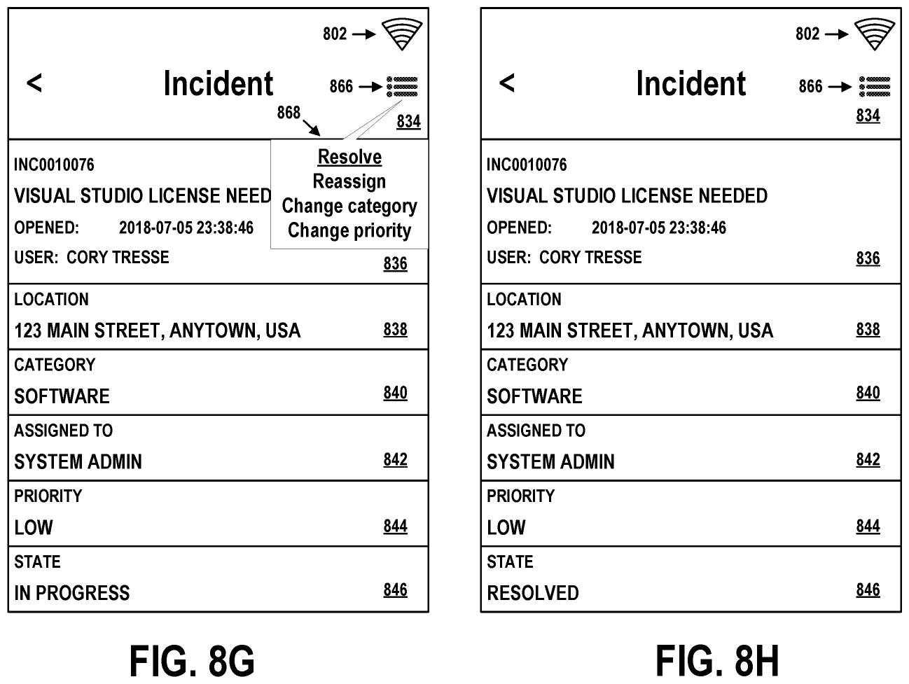

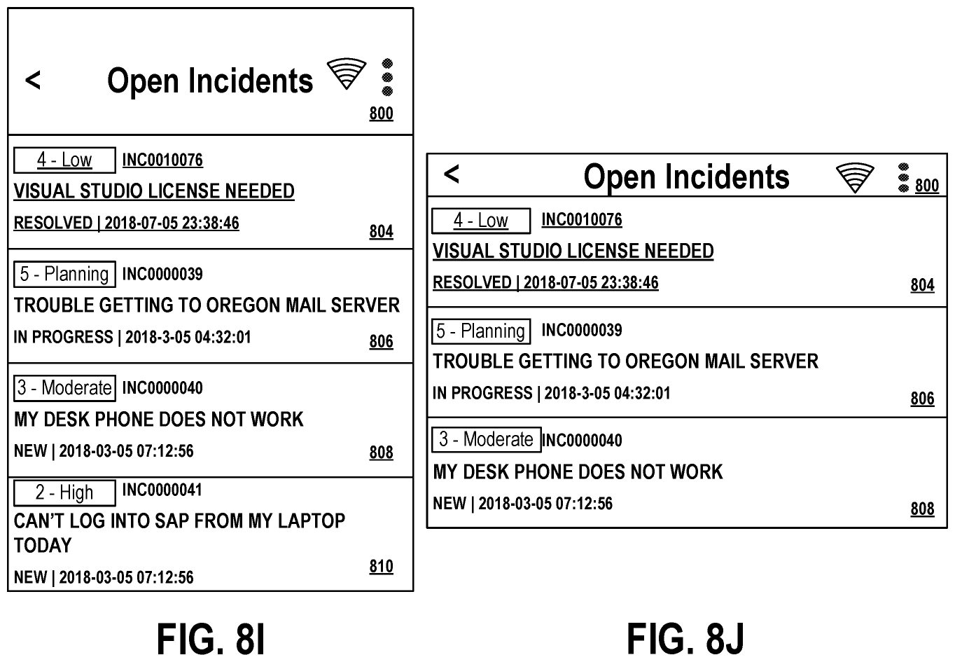

FIGS. 7A-8J provide an illustrative example of how a GUI of a native application could be defined and adapted across different wireless communication devices. In particular, FIGS. 7A-8J provide an illustrative example of how a native application can cause a GUI to be consistently displayed across different devices, regardless of the features and functionalities of those devices (e.g., orientations, platforms and operating systems, etc.). Nonetheless, the embodiments herein can operate with a wide variety of user interface layouts and designs, and should not be viewed as limited to this example.

### A. Example Encoding of Content and Arrangements Thereof

The content of a GUI, its arrangement, and any content to be displayed may be triggered by a variety of events (e.g., launching the application on the wireless communication device, selection of elements displayed thereon, etc.), all of which can be specified in data transmitted to a native application (e.g., during step 616 of FIGS. 6A and 6B, and/or step 628 of FIG. 6B). While this data can be formatted according to various protocols, one possible formatting is in accordance with JSON.

A JSON file that contains all of the information regarding the GUIs described herein could be quite large (e.g., over 1000 lines of text). For sake of simplicity, a few sections of such a JSON file are discussed below.

FIG. 7A depicts an example JSON specification 700 of a recursive, hierarchical definition of a platform-independent GUI. Notably, this example defines layout, orientation, text and image placement, text and image size, and various other text-related characteristics (e.g., color, font) for various cells in GUIs (e.g., on a wireless communication device). These attributes define the relative arrangement of a cell of a GUI, in which other cells, text, and/or images may be placed, and the arrangement defines a relative placement of this content on the GUI. Section 702 of specification 700, for example, illustrates the highest order in an ordered hierarchy of displayed content and its arrangement. In this example, section 702 defines a first-order ViewGroup as having particular dimensions (“Margin”:{“Top”:17, “Bottom”:7}), as well as a particular orientation (“Vertical”), alignment (“Left”), and distribution (“Auto”).

Turning to section 704 of specification 700, a second-order ViewGroup is illustrated, showing the displayed content and its arrangement within the first-order ViewGroup. In this example, section 704 defines a ViewGroup as having a particular orientation (“Horizontal”), alignment (“Center”), and distribution (“Auto”).

Turning to sections 706 and 708 of specification 700, third-order types of data are illustrated showing the displayed content and its arrangement within the second-order ViewGroup. In this example, section 706 defines an image “Type” as having particular dimensions (“Height”: 21, “Width”: 92, “Margin”:{“Right”: 8}), as well as string to point to a specific piece of data to be presented in this subpart (an image, shown here as “CellId”:“priority image”). Additionally, section 708 defines a text “Type” as having particular dimensions (“Margin”: {“Left”: 8}), a string to point to a specific piece of data to be presented in this subpart (text, shown here as “CellId”:“number”), and formatting for how to present that data, including color (“TextColor”: “#92a3b0”), alignment (“TextAlignment”: “Left”), how many lines or rows it should take up in the cell (“MaxLines”: 1) and font (“Font”: {“Weight”: “regular”, “Size”: 12}). Other characteristics are possible as well.

The JSON-based GUI definition of FIG. 7A may be arbitrarily large or small, may be displayed in any number of orientations, and may contain any number of cells in any recursive nesting arrangement. In some embodiments, the JSON file will also define the content that is to be displayed in these cells (e.g., text, URLs referring to images, etc.). Alternatively, this content can be defined in a separate file. Regardless of where it is located, the content may be linked to the GUI definition by the “CellId” attributes. For example, GUI definition of FIG. 7A may define a number of cells, each with a unique CellId, and the content may refer to these CellIds in order to map content values (e.g., text, URLs referring to images, etc.) to cells.

FIG. 7B depicts a tree-like hierarchical view of the sections of specification 700 as described in connection with FIG. 7A. As shown, FIG. 7B illustrates a first-order ViewGroup 710 (pertaining to a high-level layout and orientation of content to be displayed on a wireless communication device and corresponding to section 702), a second-order ViewGroup 712 (pertaining to the displayed content and its arrangement within the first-order ViewGroup 710 and corresponding to section 704), and two third-order types of data (pertaining to image-based content and text-based content to be displayed in a row of the second-order ViewGroup 712). Particularly, type 714 corresponds to section 706 and type 716 corresponds to section 708. As noted by the “ . . . ” in FIG. 7B, other content, ViewGroup[s], types, and associated characteristics are possible in connection with FIGS. 7A and 7B.

FIG. 7B demonstrates that the recursive, hierarchical GUI definition of FIG. 7A can be represented as a tree in which ViewGroup cells are root or intermediate nodes and Type cells are leaf nodes. As with the JSON definition of FIG. 7A, the tree of FIG. 7B can be arbitrarily complex and arbitrarily deep.

As seen in FIG. 7C, the JSON file excerpt in FIG. 7A can be used on various platforms to create a GUI layout in accordance with the definition therein. For example, when processed, section 702 of specification 700, might cause a cell 718 to be defined as having a particular orientation (here, vertical), alignment (here, left), and distribution of some content therein (here, e.g., auto), and to be displayed on a GUI of a wireless communication device. As illustrated in FIGS. 7A and 7B, cell 718 corresponds to section 702 and ViewGroup 710.

Cell 718 may contain cells 719, 724, and 726 (e.g., subcells of cell 718), each of which may also contain further nested cells. Cell 719 is defined by section 704 and ViewGroup 712. Here, the definitions of cells 724 and 726 are omitted from the JSON file of FIG. 7A. The vertical orientation of cell 718 causes cells 719, 724, and 726 to be arranged, overall, vertically; but, the definitions of cells 719, 724, and 726 cause them, individually, to be arranged horizontally (corresponding to section 704, e.g., for cell 719).

Specifically, cell 719 contains cells 720 and 722 (e.g., subcells of cell 719). Cell 720 is defined by section 706 and type 714, and cell 722 is defined by section 708 and type 716. The horizontal orientation of cell 719 causes cells 720 and 722 to be arranged horizontally. Note that cell 724 is depicted as not containing any subcells, while cell 726 is depicts as containing two subcells, similar to those of cell 719.

There is a direct and unambiguously-defined relationship between the GUI definition of FIG. 7A, the tree-based view thereof in FIG. 7B, and the arrangement of cells in the GUI actually being displayed in FIG. 7C. This allows a GUI to be defined programmatically, and this definition can be dynamically generated and delivered upon request to a native application.

FIG. 7D defines a class hierarchy for elements of the GUI definition described in the context of FIGS. 7A, 7B, and 7C. This hierarchy defines a recursive data structure for representing such a GUI definition.

In FIG. 7D, for example, a base class 728 can be defined (e.g., “SGView (Base Class)”). Within this base class, one or more characteristics might also be defined, including: color (e.g., “background color (String)”), margins (e.g., “margins (Struct):”, “top (Double)”, “bottom (Double)”, “left (Double)”, “right (Double)”), dimensions (“width (Double)”, “height (Double)”) and presentation (“corner radius (Double)”), and code to point to a specific piece of data to be presented in this subpart (“cell id (String)”, discussed above in terms of “CellId”).

Base class 728 contains subclasses 730, 732, and 734. The native application may use one or more of these subclasses to map content, both in terms of what is presented (e.g., text and images) and how it is presented (e.g., layout) via the GUI. Subclass 730 defines a ViewGroup as described above. Particularly, Subclass 730 specifies one or more characteristics including children to be nested within a cell defined by a ViewGroup (e.g., “children(Array<SGView>)”), alignment (e.g., “alignment (Enum)”, “center”, “left”, “right”, “top”, “bottom”, and “stretch”), orientation (e.g., “orientation (Enum)”, “vertical”, and “horizontal”), and distribution (“distribution (Enum)”, “equal”, and “fill”).

Subclass 732 defines the data type Text, data including text to be presented within a ViewGroup (e.g., “text (String)”), font (e.g., “font (String)”, “size (Double)”, “name (String)”, and “weight (Enum)”, which may be further defined as “ultralight”, “thin”, “light”, “regular”, “medium”, “semibold”, “bold”, “heavy”, and “black”), and text alignment (e.g., “text alignment (Enum)”, “left”, “right”, and “center”), as well as color (“text color (String)”), and how many lines/rows the text should take up in the cell (“max line (Int). Subclass 734 defines the data type Image, including how the image should be scaled within the cell may also be defined (e.g., “scaling (Enum)”, “fill” and “fit”).

In accordance with object-oriented design, base class 728 may represent the base view with all the base properties of a particular layout appearing on the native application, while (1) subclass 730 may inherit from base class 728, allowing the native application to arrange subparts in a vertical or horizontal layout, (2) subclass 732 may inherit from base class 728, allowing the native application to display text; and (3) subclass 734 may inherit from base class 728, allowing the native application to display one or more images.

All of these definitions are in accordance with a recursively, cell-based, spatially-organized arrangement of the content. Other characteristics, layouts, and hierarchies are possible.

### B. Example IT Trouble Ticket GUIs

To make the GUIs described herein more concrete, examples thereof depict information related to IT trouble tickets, pursuant to the encoding of content and the arrangements, as shown in FIGS. 7A-D, above.

These tickets may be opened by technology users of an enterprise who are having difficulties with hardware or software services. Each ticket may include fields defining: the priority of the ticket, a unique number or code assigned to the ticket, a brief description of the problem that the user experienced, the state of the ticket (e.g., new, being assessed, in progress, resolved, closed), and the time at which the ticket was opened, among other fields (e.g., the location of the user, the category of problem (e.g., hardware or software), to whom the ticket is assigned, the identity of the user (or caller) who opened the ticket, etc.).

FIG. 8A depicts a GUI of a wireless communication device displaying a list of open incidents. The content of this GUI contains information related to the incidents, including the priorities of the tickets, ticket numbers, brief descriptions, ticket states, and the times at which the tickets were opened are shown.

The arrangement of this content is a single column of cells, each cell containing information related to a particular ticket. Other arrangements may be used instead. For example, these arrangements may include multiple columns and/or rows of cells, such as an m×n grid of cells. Within each cell, each unit of text or graphical icon can be individually assigned a location. For instance, in cell 800, the text “Open Incidents” is vertically and horizontally centered, while the wireless connectivity icon 802 is placed in the upper right corner.

Furthermore, font and color schemes may be defined individually for a cell or for a group of cells. These schemes may set forth the size, style, and color of the text in the cells, the background color of the cells, and various other properties such as what a cell looks like when it is selected and so on.

One or more cells and one or more characteristics of those cells may be displayed by the native application. For example, pursuant to instructions stored locally, from a server device, or both, a GUI of a wireless communication device may display cell 800 containing the text “Open Incidents,” which is also displayed vertically and horizontally centered, and with the wireless connectivity icon 802 and icon 812 placed in the upper right corner. Icon 812 may be a selectable drop-down menu containing ways to change the information related to the tickets or to navigate to other menus, among other possibilities.

In a further aspect, the native application may display user interface elements to provide a layout to convey information pertaining to the different tickets. For example, cells 804, 806, 808, and 810 may be displayed to each convey information related to a single ticket.

As discussed above, the information displayed in cells 804, 806, 808, and 810 may include ticket priorities, ticket numbers, brief descriptions, ticket states, and the times at which the tickets were opened. The information that is ultimately displayed in these cells may be obtained and displayed in a number of ways.

The native application may request and receive more information than is displayed. For example, FIG. 8A only displays information related to four tickets, but the JSON file may have included information related to more than four tickets. Thus, turning back to FIG. 6A for a moment, the native application may request and receive some or all information related to a number of tickets at steps 610-616. In response to receiving the data, native application 602 may display the content that fits on the GUI in accordance with an arrangement. This allows the native application to adapt to varying wireless communication device screen sizes (e.g., a smartphone with a 6 inch screen versus a tablet with a 10 inch screen).

For example, this data may include content for display on the GUI, a defined arrangement of this content, and instructions for mapping the content. In some embodiments, the content may be formatted and arranged using JSON in accordance with FIG. 7A. Thus, native application 602 may display the content on the GUI in accordance with the arrangement defined by the received JSON, for example as shown in FIG. 7C. This content may be recursively defined and displayed as recursively-nested sets of vertical or horizontal cells containing associated values, where the content is mapped to the cells pursuant to the JSON definition (e.g., with identifiers mapping units of the content to cells pursuant to a particular arrangement).

As shown in FIG. 8A, the information displayed in cell 804 is shown as ticket priority 814, ticket number 816, brief description 818, ticket state 820, and the time at which the ticket was opened 822. The native application may display this information based a definition of cell 804 that the native application interprets as particular arrangement of the information.

Cell 804 of FIG. 8B includes five subcells that allow the presentation of information related to a single incident. Particularly, as shown in FIG. 8B, subcell 824 corresponds to ticket priority 814, subcell 826 corresponds to ticket number 816, subcell 828 corresponds to brief description 818, subcell 830 corresponds to ticket state 820, and subcell 832 corresponds to the time at which the ticket was opened. Thus, for example, the JSON file of FIG. 7A may also include definitions (not shown) for the arrangement of all three rows of subcells (the top row containing subcells 824 and 826, the middle row containing subcell 828, and the bottom row containing subcells 830 and 832). Further, the JSON file may also define the horizontal arrangement of subcells 824 and 826 within the first row, the horizontal arrangement of subcell 828 within the second row, and the horizontal arrangement of subcells 830 and 832 within the third row.

More or less information may appear in each cell and subcell, and different arrangements may be used. Advantageously, the definitions in the JSON file allow a cross-platform layout to be defined that can be consistent (though not necessarily exact) across multiple types of wireless communication device.

In one example, the JSON file may contain content in particular arrangement (e.g., cells displaying the text “Open Incidents,” a wireless connectivity icon 802, and cells 804, 806, 808, and 810 pertaining to individual tickets). Then, the native application may map this content to produce: (1) a layout in accordance with an arrangement (e.g., creating and arranging cells and subcells in a vertical and/or horizontal stacks); and (2) the content to be displayed within that arrangement (e.g., text and images to be displayed in the cells and subcells).

In one example, this may be accomplished by the native application defining a layout of one or more rows in a table-like view and populating data into these rows by mapping specific pieces of data to each row and/or the subcells within. As illustrated in FIG. 8B, the native application may display particular user interface elements (e.g., cell 804 and the subcells therein) to which it maps data. The native application may do so by creating and arranging subcells 824, 826, 828, 830, and 832, and inserting text and image content displayed as items 814, 816, 818, 280, and 822 into those cells, respectively, and according the defined arrangement. And, this all may be accomplished whether the data, information, and content is retrieved from local storage or from another device (e.g., a server device).

In a further aspect, the native application may display the spatially-organized content according to the arrangement regardless of the orientation of the wireless communication device on which it operates. As shown in FIG. 8C, the native application can display a layout in accordance with cell 804 by creating and arranging subcells 824, 826, 828, 830, and 832 according to a portrait orientation. As shown in FIG. 8D, when the wireless communication device is rotated into a landscape orientation mode, the native application responds by extending user interface elements (including cell 804), but maintains the proportions of the subcells 824, 826, 828, 830, and 832 of the still-displayed user interface elements. In this way, the recursively-defined, cell-based arrangement of the content to be displayed in these subcells maintains it spatial organization according to the arrangement (as well as other characteristics, like text size), regardless of the orientation of the device.

Alternatively, a change in orientation may cause the native application to scale the content in subcells 824, 826, 828, 830, and 832 in relationship to the extended cell 804 (e.g. proportionally). In this way, the recursively-defined, cell-based arrangement of the content to be displayed in these subcells may maintain spatial organization as compared to each other, but may appear different in some ways (e.g., larger text size) depending on the orientation of the device. Other example configurations are possible.

FIG. 8E depicts a scenario where cell 804 (and its constituent subcells) is selected. This selection is depicted by underlining. Responsive to the selection, the native application may request further data to be received and displayed in a second GUI containing further details and context for the content previously displayed within cell 804. This process may cause the GUI of FIG. 8F to be displayed. Notably, this GUI depicts a more detailed version of the ticket in cell 804, and may use information received at step 616.

Cell 834 of FIG. 8F indicates that this GUI is related to a single incident, and also includes the wireless connectivity icon 802 (placed in the upper right corner) and a menu icon 866. By transitioning into this second GUI, information that was previously displayed may be reformatted, mapped to one or more additional user interface elements, and displayed via the wireless communication device, along with content that was not previously displayed but possibly pertaining to the previously displayed content. For example, in cell 836 the ticket number 848, brief description 850, and time/date 852 at which the ticket was opened are redisplayed (albeit, in some cases, in a different format). Similarly, cell 844 identifies the priority 862 of the ticket and cell 846 identifies the state 864 of the ticket. Additionally, information that was not previously displayed but that pertains to the ticket may also be displayed (e.g., cell 836 identifies the user 854 who opened the ticket, cell 838 identifies the user's location 856, cell 840 identifies the category 858 of the ticket, and cell 842 identifies to whom the ticket is assigned 860). In general, more or less information, or different information, could be displayed in a GUI that provides details of a ticket, all of which may be accomplished by the embodiments described herein.

FIG. 8G shows a GUI that may be include a selectable drop-down menu 868 containing ways to change the information related to the ticket. For example, FIG. 8G depicts the same GUI as FIG. 8F, but with icon 866 selected and drop-down menu 868 displayed. Drop-down menu 868 provides the user with options to resolve the incident (e.g., change the state to “resolved”), reassign the incident (e.g., change person or group to whom the incident is assigned), change the category of the incident, and change the priority of the incident. Again, the native application may derive this menu by requesting and receiving further data from a server device and generating a graphical representation of the content according to spatially organized arrangement, all according to a selection of drop-down menu 868. For instance, a JSON file may define one or more overlay cells to be positioned atop and relative to one of the other defined cells or subcells.

FIG. 8G also depicts that the resolve option of drop-down menu 868 has been selected. Accordingly, FIG. 8H depicts the GUI of FIGS. 8F and 8G updated to reflect this change. Notably, cell 846 is updated to indicate that the state of the ticket is now “resolved.” Once more, the native application may derive this change by one or more protocols associated with the selection of the resolve option of drop-down menu 868.

Additionally, FIG. 8I shows an updated version of FIG. 8A; particularly, the information in cell 804 indicates that the state of the ticket is now “resolved.” In a further aspect shown in FIG. 8J, the native application may display the spatially-organized content according to the arrangement regardless of the orientation of the device. This may be accomplished by maintaining the layout, proportions, and the content contained in cell 804 (shown) or by scaling the content in cell 804 (not shown). Furthermore, in another embodiment, because the incident shown in cell 804 is resolved (and thus is no longer “open”), the native application may remove any indication of the ticket from the GUI and rearrange the displayed content accordingly (e.g., by replacing the content in cell 804 with the content in cell 806, and so on). Although the examples shown in FIGS. 8A-8H pertains primarily to the state and details of ticket INC0010076, other tickets within these examples may function similarly, although other functionalities, arrangements, and configurations are possible as well.

These embodiments allow the recursive specification of a hierarchical, cell-based GUI that can be displayed on various wireless communication devices, regardless of screen size, screen orientation, or hardware configuration. This specification may reside in a JSON file (or a similar type of structured file such as XML). The file may include the specification, which defines the arrangement of cells and subcells within the GUI, as well as the data (text and URLs of image files) that is to be displayed in this GUI. Thus, the drawbacks and limitations of using a traditional web browser to display this information are overcome without the need to specifically program the GUI specification into the native application. In this way, and others, a technical improvement is presented to an industry problem as the native application reads the JSON file and displays information according to the specification therein, instead of relying on traditional programming methods.

### VII. Example Operations

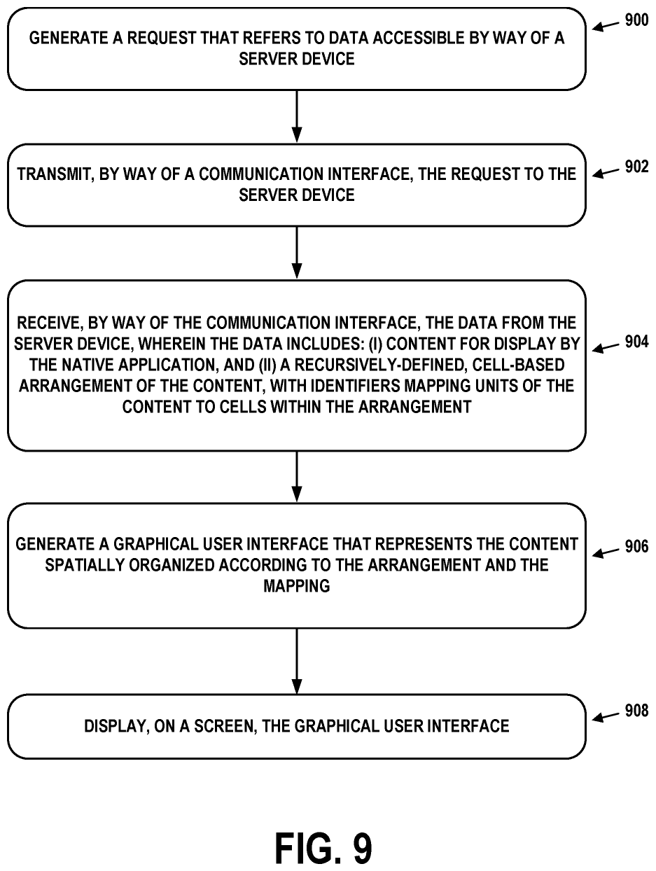

FIG. 9 is a flow chart illustrating an example embodiment. The process illustrated by FIG. 9 may be carried out by software provided on or downloaded to a wireless communication device or some other type of device exemplified by computing device 100. However, the process can be carried out by other types of devices or device subsystems.

The embodiments of FIG. 9 may be simplified by the removal of any one or more of the features shown therein. Further, these embodiments may be combined with features, aspects, and/or implementations of any of the previous figures or otherwise described herein.

Block 900 may involve generating, by a native application executing on a wireless communication device, a request that refers to data accessible by way of a server device.

Block 902 may involve transmitting, by way of a communication interface, the request to the server device.

Block 904 may involve receiving, by way of the communication interface, the data from the server device, wherein the data includes: (i) content for display by the native application, and (ii) a recursively-defined, cell-based arrangement of the content, with identifiers mapping units of the content to cells within the arrangement.

Block 906 may involve generating a GUI that represents the content spatially organized according to the arrangement and the mapping.

Block 908 may involve displaying, on a screen on the wireless communication device, the GUI.

In some embodiments, the cells within the arrangement contain the identifiers, the identifiers in the cells also appear in the units of the content, and generating the GUI comprises the native application using the mapped identifiers to place the units of the content within the cells.

In some embodiments, the content comprises text to be displayed within a first set of the cells, the content also comprises references to image files stored on the server device, and the image files are to be displayed within a second set of the cells.

In some embodiments, generating the GUI comprises retrieving at least some of the image files from the server device and including the retrieved image files in the GUI.

In some embodiments, generating the GUI comprises aligning, orienting, and distributing at least some of the cells within the arrangement such that the GUI fits within the screen.

In some embodiments, the arrangement defines a relative placement of the units of the content on the GUI, and generating the GUI comprises displaying the units of the content in positions on the GUI determined by the relative placement.

In some embodiments, the data is in JSON format.

In some embodiments, generating the GUI comprises: (i) reading the arrangement into a tree-like data structure, where intermediate nodes of the tree-like data structure represent ViewGroups that encapsulate two or more of the cells, and where leaf nodes of the tree-like data structure each represents one of the cells; (ii) populating the leaf nodes with the units of the content; and (iii) forming the GUI by traversing the tree-like data structure.

Some embodiments further include: (i) receiving, by way of the GUI, input that modifies at least some of the units of the content; (ii) generating a request that refers to updated data accessible by way of the server device; (iii) transmitting, by way of the communication interface, the request to the server device; (iv) receiving, by way of the communication interface, the updated data from the server device, where the updated data includes: additional content for display by the native application, and an update to the arrangement; (v) generating an updated GUI that represents the additional content spatially organized according to the updated arrangement; and (vi) displaying, on the screen, the updated GUI.

Some embodiments may further include: (i) determining that the wireless communication device has changed physical orientation between landscape and portrait orientation modes; and (ii) generating an updated GUI that represents the content spatially organized according to the arrangement and the mapping, where the updated GUI contains less or more of the content than the GUI prior to updating.

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A wireless communication device comprising:
a communication interface;
a screen configured to display graphical user interfaces of a native application;
a processor; and
memory containing instructions of the native application that, when executed by the processor, cause the wireless communication device to perform operations including:
generating a request that refers to data accessible by way of a server device;
transmitting, by way of the communication interface, the request to the server device;
receiving, by way of the communication interface, the data from the server device, wherein the data includes: (i) content for display by the native application, and (ii) a recursively-defined, cell-based arrangement of the content, with identifiers mapping units of the content to cells within the arrangement;
generating a graphical user interface that represents the content spatially organized according to the arrangement and the mapping; and
displaying, on the screen, the graphical user interface.

2. The wireless communication device of claim 1, wherein the cells within the arrangement contain the identifiers, wherein the identifiers in the cells also appear in the units of the content, and wherein generating the graphical user interface comprises the native application using the mapped identifiers to place the units of the content within the cells.

3. The wireless communication device of claim 1, wherein the content comprises text to be displayed within a first set of the cells, wherein the content also comprises references to image files stored on the server device, and wherein the image files are to be displayed within a second set of the cells.

4. The wireless communication device of claim 3, wherein generating the graphical user interface comprises retrieving at least some of the image files from the server device and including the retrieved image files in the graphical user interface.

5. The wireless communication device of claim 1, wherein generating the graphical user interface comprises aligning, orienting, and distributing at least some of the cells within the arrangement such that the graphical user interface fits within the screen.

6. The wireless communication device of claim 1, wherein the arrangement defines a relative placement of the units of the content on the graphical user interface, and wherein generating the graphical user interface comprises displaying the units of the content in positions on the graphical user interface determined by the relative placement.

7. The wireless communication device of claim 1, wherein the data is in JavaScript Object Notation (JSON) format.

8. The wireless communication device of claim 1, wherein generating the graphical user interface comprises:
reading the arrangement into a tree-like data structure, wherein intermediate nodes of the tree-like data structure represent ViewGroups that encapsulate two or more of the cells, and wherein leaf nodes of the tree-like data structure each represents one of the cells;
populating the leaf nodes with the units of the content; and
forming the graphical user interface by traversing the tree-like data structure.

9. The wireless communication device of claim 1, wherein the operations further include:
receiving, by way of the graphical user interface, input that modifies at least some of the units of the content;
generating a request that refers to updated data accessible by way of the server device;
transmitting, by way of the communication interface, the request to the server device;
receiving, by way of the communication interface, the updated data from the server device, wherein the updated data includes: (i) additional content for display by the native application, and (ii) an update to the arrangement;
generating an updated graphical user interface that represents the additional content spatially organized according to the updated arrangement; and
displaying, on the screen, the updated graphical user interface.

10. The wireless communication device of claim 1, wherein the operations further include:
determining that the wireless communication device has changed physical orientation between landscape and portrait orientation modes; and
generating an updated graphical user interface that represents the content spatially organized according to the arrangement and the mapping, wherein the updated graphical user interface contains less or more of the content than the graphical user interface prior to updating.

11. A computer-implemented method comprising:
generating, by a native application executing on a wireless communication device, a request that refers to data accessible by way of a server device;
transmitting, by way of a communication interface, the request to the server device;
receiving, by way of the communication interface, the data from the server device, wherein the data includes: (i) content for display by the native application, and (ii) a recursively-defined, cell-based arrangement of the content, with identifiers mapping units of the content to cells within the arrangement;
generating a graphical user interface that represents the content spatially organized according to the arrangement and the mapping; and
displaying, on a screen of a wireless communication device, the graphical user interface.

12. The computer-implemented method of claim 11, wherein the cells within the arrangement contain the identifiers, wherein the identifiers in the cells also appear in the units of the content, and wherein generating the graphical user interface comprises the native application using the mapped identifiers to place the units of the content within the cells.

13. The computer-implemented method of claim 11, wherein the content comprises text to be displayed within a first set of the cells, wherein the content also comprises references to image files stored on the server device, and wherein the image files are to be displayed within a second set of the cells.

14. The computer-implemented method of claim 13, wherein generating the graphical user interface comprises retrieving at least some of the image files from the server device and including the retrieved image files in the graphical user interface.

15. The computer-implemented method of claim 11, wherein generating the graphical user interface comprises aligning, orienting, and distributing at least some of the cells within the arrangement such that the graphical user interface fits within the screen.

16. The computer-implemented method of claim 11, wherein the arrangement defines a relative placement of the units of the content on the graphical user interface, and wherein generating the graphical user interface comprises displaying the units of the content in positions on the graphical user interface determined by the relative placement.

17. The computer-implemented method of claim 11, wherein the data is in JavaScript Object Notation (JSON) format.

18. The computer-implemented method of claim 11, wherein generating the graphical user interface comprises:
reading the arrangement into a tree-like data structure, wherein intermediate nodes of the tree-like data structure represent ViewGroups that encapsulate two or more of the cells, and wherein leaf nodes of the tree-like data structure each represents one of the cells;
populating the leaf nodes with the units of the content; and
forming the graphical user interface by traversing the tree-like data structure.

19. The computer-implemented method of claim 11, further comprising:
determining that the wireless communication device has changed physical orientation between landscape and portrait orientation modes; and
generating an updated graphical user interface that represents the content spatially organized according to the arrangement and the mapping, wherein the updated graphical user interface contains less or more of the content than the graphical user interface prior to updating.

20. An article of manufacture including a non-transitory computer-readable medium, having stored thereon program instructions that, upon execution by a native application executing on a wireless communication device, cause the wireless communication device to perform operations comprising:
generating a request that refers to data accessible by way of a server device;
transmitting, by way of a communication interface of the wireless communication device, the request to the server device;
receiving, by way of the communication interface, the data from the server device, wherein the data includes: (i) content for display by the native application, and (ii) a recursively-defined, cell-based arrangement of the content, with identifiers mapping units of the content to cells within the arrangement;
generating a graphical user interface that represents the content spatially organized according to the arrangement and the mapping; and
displaying, on a screen of a wireless communication device, the graphical user interface.
